(19) United States
(12) Patent Application Publication
(10) Pub. No.: US 2009/0027925 A1
(43) Pub. Date: Jan. 29, 2009

(54) SWITCHING POWER SUPPLY

(75) Inventors: Akihiko KANOUDA, Hitachinaka (JP); Makoto KITAMURA, Yokohama (JP); Fusao SAKURAMORI, Yokohama (JP); Takeshi MOCHIZUKI, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd

(21) Appl. No.: 12/174,175

(22) Filed: Jul. 16, 2008

(30) Foreign Application Priority Data
Jul. 24, 2007 (JP) 2007-191537

(51) Int. Cl. H02M 3/335

(52) U.S. Cl. 363/21.13

(57) ABSTRACT

A buck-boost converter of an H bridge type having a function for initially charging a smoothing output capacitor without a relay and a rush current preventing resistance. A compact and flat power supply is attained by employing a current critical mode H bridge system for a PFC converter and providing a function of initially charging a smoothing output capacitor to a converter circuit.

### BACKGROUND OF THE INVENTION

The present invention relates to a switching power supply which corrects a power factor of an AC input current.

The simplest arrangement of rectifying and smoothing an AC current obtained from an AC power supply to obtain a DC current is to use a diode bridge and a smoothing capacitor. However, this arrangement involves reduction in power factor or increase in input harmonics, because the arrangement becomes a so-called capacitor input type of rectification circuit wherein an input current flows only in the vicinity of the peak of a power voltage. A problem with input harmonics must be treated based on the International Standard, so a measure against the input harmonics is required to be taken according to an input power. To this end, various converters including a PFC (Power Factor Correction) converter and a high power factor converter have been proposes.

A boost type PFC converter in the aforementioned converters has the most general circuit configuration. In this circuit configuration, a serial circuit of a coil and a switch is connected between a plus and minus terminals of an AC rectifying diode bridge, an anode of a boost diode is connected to a connection point between the coil and the switch, a cathode of the boost diode is connected to a high voltage side of a smoothing output capacitor, and low voltage side of the smoothing output capacitor is connected to a minus terminal of the diode bridge.

In the fields of home electric appliances or information devices, on the other hand, remarkable tendency is, in these years, to lower the cost of such a PFC converter or to increase the performance thereof. And efforts are being made to devise the configuration of the PFC converter.

An example of such tendencies is proposed in JP-A-2004-208389 as a technique. In this proposal, a circuit configuration called an H bridge is employed for the PFC converter to reduce a PFC circuit voltage, thus providing a good PFC circuit and eliminating the need for provision of a high-breakdown-voltage component.

### SUMMARY OF THE INVENTION

It is therefore an object of the present invention is to provide a switching power supply which improves three points, that is, (1) lowering an efficiency at a voltage of AC 100V, (2) eliminating hindrance factors of attaining a compact and flat arrangement, and (3) removing waveform distortion, and which also be made compact and flat, high in efficiency and low in noise.

Explanation will first be made as to problems in a prior art switching power supply having a boost type PFC converter from the viewpoints of the above 3 points. With regard to the point (1) of the efficiency, in the prior art PFC converter, since a boost ratio becomes high especially at the time of inputting a voltage of AC 100V, the prior art has a problem with a low efficiency, which is to be essentially resolved.

With respect to the point (2), since the prior art requires a relay, this hinders the achievement of a compact and flat structure. When the power is turned ON and the smoothing output capacitor is not charged yet, a rush current to the smoothing output capacitor is prevented by employing a method of arranging a parallel circuit of the relay and an initial charge resistor or a thermistor at a preceding stage of a boot converter, initially charging the smoothing output capacitor via the initial charge resistor or the thermistor having a high impedance with the relay turned OFF, and then turning ON the relay after completion of the initial charge to reduce the input impedance and a stationary loss. For the purpose of securing the safety of the circuit, further, a power sent downstream of the PFC converter is cut off upon an abnormal situation. To this end, apart from the relay used for the initial charge, a relay for turning ON/OFF the power supply is provided in many cases. Thus the two relays, through which a main current flows, are mounted on a main circuit to be connected in series. However, since these relays cannot be surface-mounted on the board nor mounted with their sides laid thereon, the relays have heights of about 15 to 20 mm on the board. This involves a hindrance cause of achievement of a compact and flat switching power supply.

With respect to the point (3), when the input current has a discontinuous waveform, waveform distortion becomes high, and that is a problem.

In the circuit configuration set forth in the aforementioned JP-A-2004-208389, with regard to the efficiency point (1), since a voltage across the smoothing output capacitor can be made low when compared with that of the boost type PFC converter, the boost ratio can be made low. Thus, it is expected that the above prior art can increase the efficiency over the boost type PFC converter. However, the two switches are simultaneously turned ON or OFF always independently of a magnitude relationship between the instantaneous value of the input voltage and the voltage value of the smoothing output capacitor. This disadvantageously results in that the input power is always cut off in such a mode as to emit an energy stored in the coil when the switches are turned OFF toward the smoothing output capacitor, the input current becomes completely zero, and the waveform of the input current becomes discontinuous. Thus an energy transfer efficiency from the input side to the output side becomes low. As a result, in the circuit of JP-A-2004-208389, the amount of input current per once switching operation is increased when compared with in a general boost type circuit, and this is disadvantageous from the viewpoint of circuit efficiency. The always-discontinuous waveform of the input current causes the waveform distortion in the point (3) to become correspondingly large. In this connection, JP-A-2004-208389 fails to describe the achievement of the compact and flat structure of the point (2).

In accordance with an aspect of the present invention, the above problems can be solved by providing a buck-boost switching power supply including an H bridge converter at an input stage having a high side switch and a low side switch connected in series via a choke coil. The high side switch is turned ON and the low side switch is turned ON and OFF when the absolute value of an instantaneous value of an input voltage is lower than an output voltage. The high side switch and the low side switch are simultaneously turned ON or OFF to put the current of the choke coil in a critical mode when the absolute value of the instantaneous value of the input voltage is higher than the output voltage, thus controlling power factor correction.

In the buck-boost switching power supply, the high and low side switches are simultaneously switched with a time width inversely proportional to the instantaneous value of the input voltage to put the power supply in the current critical mode. As a result, the smoothing output capacitor is controlled to have a constant charge current.

The buck-boost switching power supply includes an integrated circuit (IC) of a control circuit for performing the initial charging operation and power factor correcting operation, a level shift circuit for transmitting a drive signal of the high side switch to a high voltage side, and drive circuits for the high and low side switches.

In the buck-boost switching power supply, the integrated circuit has a terminal for receiving a power boot/shutdown signal from a system.

The buck-boost switching power supply includes two channels of such H bridge circuits which perform 2-phase interleaving operation in a current critical mode.

In the buck-boost switching power supply according to the present invention, a unit has a full height not smaller than 6 mm and smaller than 10 mm, the unit is mounted on a rear side of a liquid crystal panel of a television set or on a rear side of an image monitor device, and the panel when the unit is set thereon has a thickness not smaller than 20 mm and not larger than 35 mm.

Since the buck-boost switching power supply uses the H bridge circuits, an efficiency at a voltage of AC 100V can be increased.

The buck-boost switching power supply can initially charge the smoothing output capacitor while controlling a charge current to the capacitor at a constant level upon turning ON the power. For this reason, there can be no risk of an excess current, and the initial charge time can be shortened. For example, a time from turning ON of the power to the start of the television set can be shortened.

Additionally, the buck-boost switching power supply can reduce the loss of initial charge.

In the buck-boost switching power supply, a power for the PFC converter and subsequent components can cut off by turning OFF the high side switch even in an abnormal state. Thus, the switching power supply can advantageously eliminate the need for provision of a relay for turning ON/OFF the power, reduce the number of necessary components, reduce a relay drive power, and reduce a cost.

### BRIEF DESCRIPTION OF THE DRAWINGS

FIG. 1 shows a circuit diagram of a buck-boost switching power supply in accordance with a first embodiment of the present invention;

FIG. 2 shows diagrams for explaining operational modes of the power supply in the first embodiment;

FIG. 3 is a diagram showing waveforms of signals appearing at various points in an initial charge mode of the first embodiment;

FIG. 4 is a diagram showing waveforms of the signals appearing at the various points in a stationary operation mode in the first embodiment;

FIG. 5 is a diagram showing a waveform of an input current in the first embodiment;

FIG. 6 shows a main circuit of an interleave buck-boost switching power supply in accordance with a second embodiment of the present invention;

FIG. 7 is a control circuit of the interleave buck-boost switching power supply of the second embodiment;

FIG. 8 is a diagram showing waveforms of signals appearing various points in the initial charge mode of the second embodiment;

FIG. 9 is a diagram showing waveforms of the signals appearing the various points in the stationary operation mode of the second embodiment;

FIG. 10 is a main circuit of a buck-boost switching power supply in accordance with another embodiment similar to FIG. 1; and

FIG. 11 is a control circuit of the buck-boost switching power supply of the embodiment similar to FIG. 7.

### DESCRIPTION OF THE EMBODIMENTS

Embodiments of the present invention will be explained with reference to the attached drawings.

### Embodiment 1

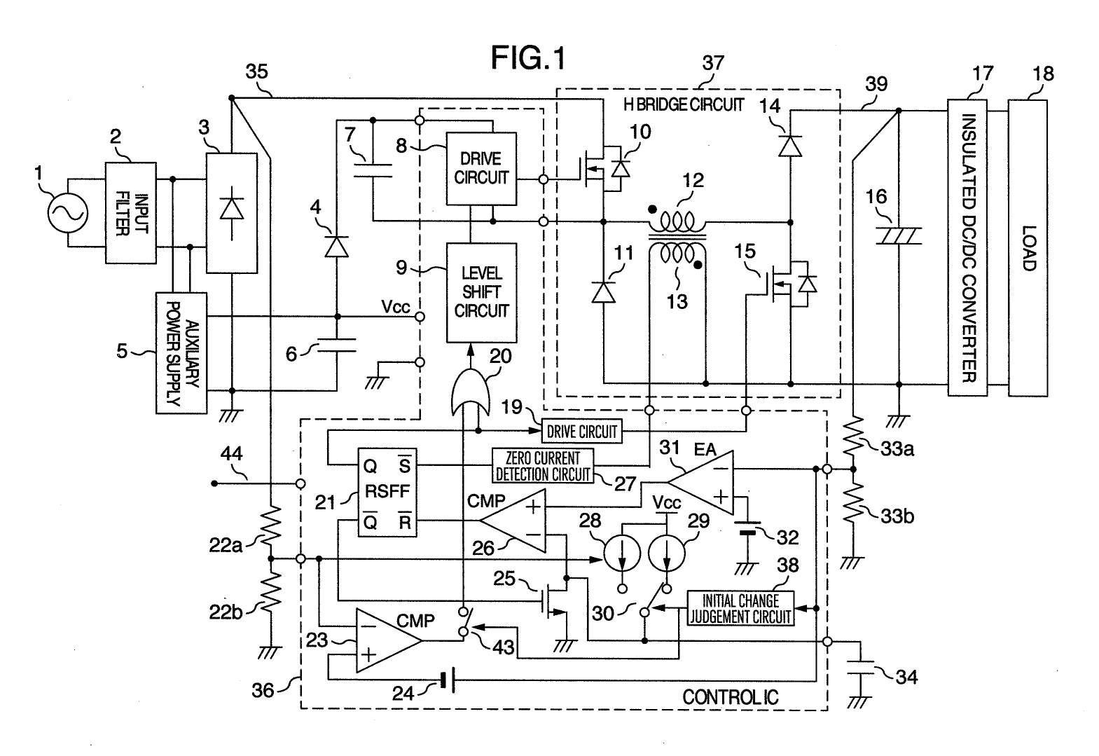

A first embodiment of the present invention will be explained by referring to FIGS. 1, 2, 3, 4, and 5.

FIG. 1 is a circuit diagram of a buck-boost switching power supply in accordance with the first embodiment. Explanation will be made as to the arrangement of FIG. 1. A power of an AC power source 1 is passed through an input filter 2 and a rectifier 3 to appear as an input voltage 35 having a full-wave rectified waveform. The input filter 2 is connected with an auxiliary power source 5. A DC output side of the rectifier 3 is connected with a voltage division resistances 22a, 22b and also with a drain of a high side power MOS FET 10. A source of the high side power MOS FET 10 is connected with one end (winding start) of a choke coil 12 and with a cathode of a free wheeling diode 11. An anode of the free wheeling diode 11 is connected to the ground of the rectifier 3. Also connected to the other end of the choke coil 12 are a drain of a low side power MOS FET 15 and an anode of a boost diode 14. The low side power MOS FET 15 is connected at its source to the ground, and the boost diode 14 is connected at its cathode to a high voltage side of a smoothing output capacitor 16.

The smoothing output capacitor 16 is connected at its lower voltage side to the ground. The high side power MOS FET 10, the free wheeling diode 11, the choke coil 12, the low side power MOS FET 15, and the boost diode 14 form an H shape, which are known as an H bridge circuit 37.

Connected to the high voltage side of the smoothing output capacitor 16 are a pair of voltage division resistances 33a, 33b which are connected in series and an insulated DC/DC converter 17. An output of the insulated DC/DC converter 17 is connected with a load 18. The choke coil 12 has an auxiliary winding 13, one end (winding start) of which is grounded and the other end of which is connected to a zero current detection circuit 27 in the control IC 36.

A voltage across the smoothing output capacitor 16 is referred to as an output voltage 39. A middle point between the voltage division resistances 33a, 33b is connected to an error amplifier 31, an offset 24, and an initial charge judgment circuit 38 within a control IC 36. An output of the offset 24 is connected to a comparator 23.

A middle point between the voltage division resistances 22a, 22b is connected to the comparator 23 and a variable current source 28 within the control IC 36. The control IC 36 has the same GND (ground) potential as a source potential of the low side power MOS FET 15. The control IC 36 has a voltage reference 32, which in turn is connected to the error amplifier 31. An output of the error amplifier 31 is connected to a comparator 26. A constant current source 29 and variable current source 28 are connected to a power source Vcc within the control IC, and outputs of the constant current source 29 and the variable current source 28 are connected to a switch 30. The switch 30 plays a role of selecting any one of the outputs of the constant current source 29 and the variable current source 28 according to an output of the initial charge judgment circuit 38 and of connecting a capacitor 34 provided outside of the control IC 36 and the current source to charge the capacitor with electric charges.

The output of the initial charge judgment circuit 38 is also connected to a switch 43 to control the ON/OFF operation of the switch 43. The capacitor 34 is connected not only to the switch 30 within the control IC but also to a drain of a MOS FET 25 and to the comparator 26 within the control IC. The MOS FET 25 is connected at its source to the ground and at its gate to a Q bar output of an RS flip-flop 21. An output of the comparator 26 is connected to an R bar input of the RS flip-flop 21. The zero current detection circuit 27 is connected at its output to an S bar input of the RS flip-flop 21. An output of the RS flip-flop 21 is connected to a drive circuit 19 and an OR circuit 20. An output of the drive circuit 19 is connected to a gate of the low side power MOS FET 15. An output of the comparator 23 is connected to the OR circuit 20 via the switch 43. An output of the OR circuit 20 is connected to a level shift circuit 9, and an output of the level shift circuit 9 is input to a drive circuit 8.

The drive circuit 8 is connected to a capacitor 7 provided outside of the control IC 36. An output of the drive circuit 8 is connected to a gate of the high side power MOS FET 10. An output of the auxiliary power source 5 is connected to a capacitor 6, so that an output of the capacitor 6 is input to the control IC as Vcc and also connected to the capacitor 7 via a diode 4. The control IC 36 has an ON/OFF signal input terminal 44 which controls the general operation of the control IC 36. The terminal 44 is provided outside of the control IC 36.

The operation of FIG. 1 will next be explained. When the smoothing output capacitor 16 is first not charged at all, connection of the AC power source 1 to the switching power supply causes the input voltage 35 to be applied to the drain of the high side power MOS FET 10 through the input filter 2 and the rectifier 3. Simultaneously with this, the auxiliary power source 5 starts its operation.

The output of the auxiliary power source 5 is isolated from its input, and applied to the capacitor 6 as the voltage Vcc of 15V. The voltage Vcc is input to the control IC 36 as a control power to initiate the control IC 36. In an initial mode, the high side power MOS FET 10 and the low side power MOS FET 15 are both put in their OFF state. A voltage across the smoothing output capacitor 16 is zero, so that a current flows through a path of voltage Vcc—diode 4—capacitor 7—choke coil 12—boost diode 14—smoothing output capacitor 16—ground.

Since the capacitor 7 has a capacitance much smaller than that of the smoothing output capacitor 16, the capacitor 7 is charged up to about 15V. When the voltage Vcc is applied to the control IC 36 and an ON signal is input to the ON/OFF signal input terminal 44, the initial charge judgment circuit 38 and the zero current detection circuit 27 start their operations. A current flowing through the choke coil 12 is zero when the initial charge current of the capacitor 7 becomes null. Thus the zero current detection circuit 27 causes a set signal to be input to the RS flip-flop 21, so that and a Q output of the flip-flop becomes high. This correspondingly causes the Q output to be transmitted to the drive circuit 19 as a drive signal, so that the low side power MOS FET 15 is turned ON. Simultaneously with this, the Q output is passed through the OR circuit 20 and the level shift circuit 9 and then transmitted to the drive circuit 8. The drive circuit 8 turns ON the high side power MOS FET 10 using the energy charged in the capacitor 7.

A Q bar output is changed from a high level to a low level, so that the MOS FET 25 is turned OFF. As a result, the capacitor 34 so far short-circuited starts its charging operation. At this time, since a voltage across the smoothing output capacitor 16 is zero, the initial charge judgment circuit 38 determines the current state as an initial charge mode and causes the switch 30 to be connected to the variable current source 28. Meanwhile, since the switch 43 is turned OFF, the output of the comparator 23 is not transmitted to the OR circuit 20, so that the input of the OR circuit becomes a low level and the output signal of the RS flip-flop 21 is sent to the level shift circuit 9 as it is without being processed.

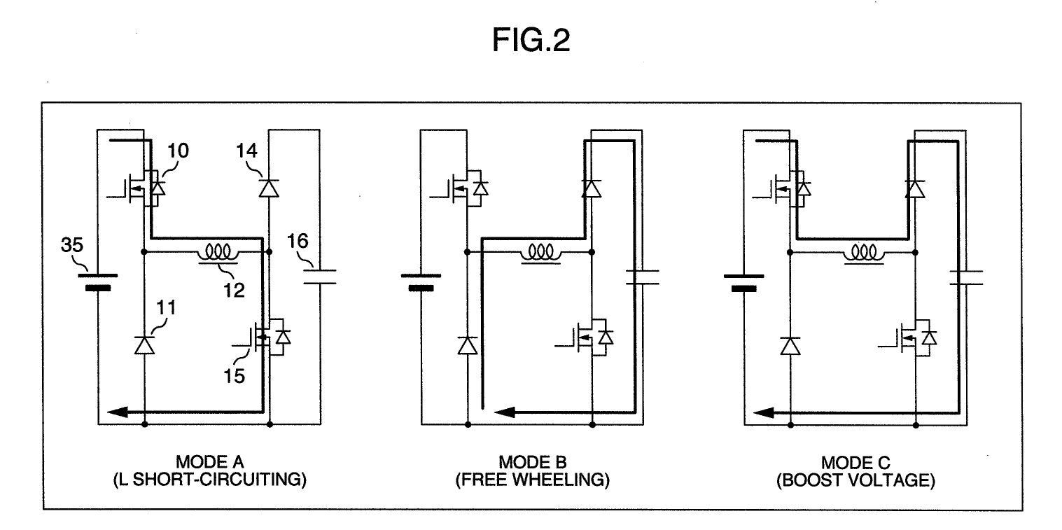

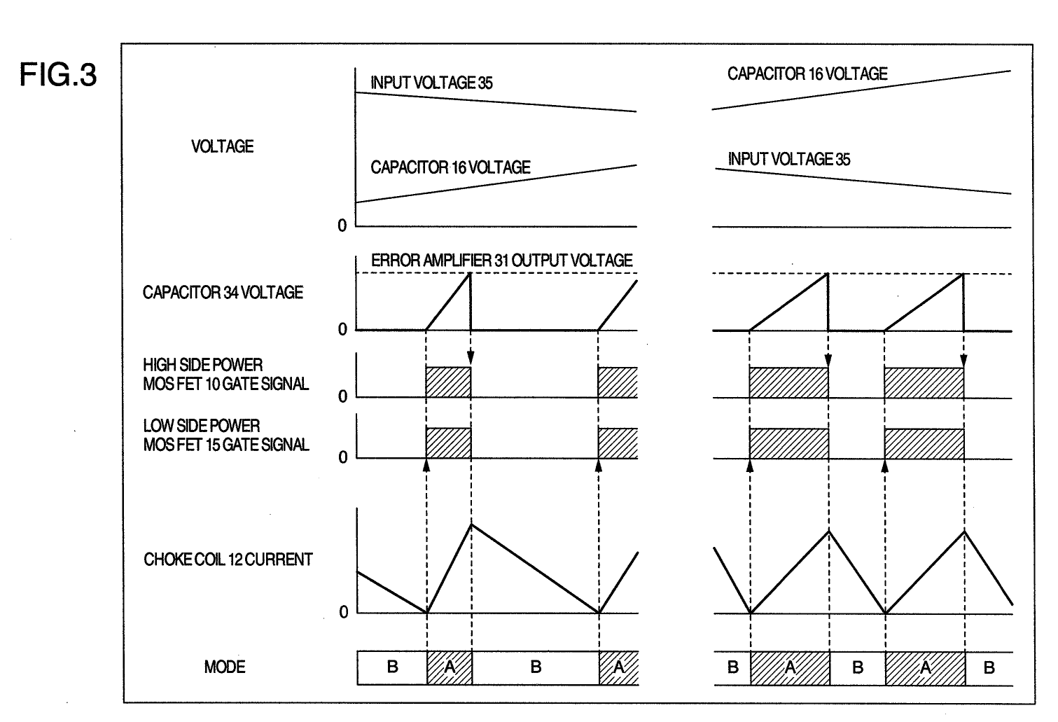

Simultaneously when the high side power MOS FET 10 and the low side power MOS FET 15 are turned ON, the capacitor 34 starts its charging operation from the variable current source 28. The amount of a current flowing through the variable current source 28 can be varied according to a voltage obtained by dividing the input voltage 35 by the voltage division resistances 22a, 22b. The amount of a current flowing through the variable current source 28 is proportional to the instantaneous value of the input voltage 35. Since the switch 30 is connected to the variable current source, the capacitor 34 is charged with a current output from the variable current source 28. The capacitor 34 has a capacitance of, for example, about 0.01 μF. Since the error amplifier 31 receives a zero voltage across the smoothing output capacitor 16 as its one input, the error amplifier outputs a constant DC voltage (V31) to the comparator 26. When the capacitor 34 is charged up to this DC voltage, the comparator 26 inverts its so-far high level to a low level, so that a reset signal is input to the RS flip-flop 21 from the comparator 26. Since the error amplifier 31 outputs the constant voltage (V31), this means that a time until the voltage of the capacitor 34 reaches the voltage of the error amplifier 31 is inversely proportional to the value of the input voltage 35. During a period (Ton period) of the high and low side power MOS FETs 10 and 15 put in their ON states, a current flows through a path in a mode A of FIG. 2 and the choke coil 12 is charged with the current or energy. Waveforms of signals appearing at various points in FIG. 2 are as shown in FIG. 3, that is, the current flowing through the choke coil 12 rises as illustrated.

When a current increase rate at this time is denoted by di/dt, the inductance of the choke coil 12 is denoted by L and the value of the input voltage 35 is denoted by Vin; the current increase rate is expressed by the following equation (1).

di/dt=Vin/L (1)

When a conversion gain from the current I of the variable current source 28 to the input voltage 35 thereof is denoted by G, the current I of the variable current source 28 is expressed by the following equation (2).

I=G·Vin (2)

Accordingly, Ton is expressed as follows.

Ton=C34·V31/(G·Vin) (3)

, wherein the capacitance of the capacitor 34 is denoted by C34.

The peak value Ipeak of the current of the choke coil 12 is expressed as follows.

Ipeak=C34·V31/(G·L) (4)

As shown by the equation (4), the peak current value becomes constant regardless of the instantaneous value of the voltage Vin.

When the reset signal is input to the RS flip-flop 21, the Q output is inverted from a high level to a low level, so that the high and low side power MOS FETs 10 and 15 are both turned OFF. A current path at this time is as shown in a mode B of FIG. 2. That is, an energy accumulated in the choke coil 12 through a path of free wheeling diode 11—choke coil 12—boost diode 14—smoothing output capacitor 16—ground is discharged in the smoothing output capacitor 16 to charge the smoothing output capacitor 16. The timing and waveforms of the signals at this time are shown in FIG. 3. The current flowing through the choke coil 12 drops as shown in FIG. 3.

A current decrease rate of the choke coil 12 at this time is expressed as follows.

−di/dt=Vout/L (5)

Wherein a voltage across the smoothing output capacitor 16 is denoted by Vout. As the voltage of the smoothing output capacitor 16 increases, the gradient of the current is abruptly increased. In the initial charge state, since the peak value flowing through the choke coil 12 or the peak value flowing through the smoothing output capacitor 16 is defined by the equation (4), these current peak values can be set by adjusting the constants. G and V31 are set at constant values and the current peak value is adjusted by controlling the values of L and C34.

When the current of the choke coil 12 drops down to zero, the auxiliary winding 13 and the zero current detection circuit 27 detect the fact that the zero current detection circuit inputs the set signal to the RS flip-flop 21, with the result that the high and low side power MOS FETs 10 and 15 are again turned ON. In the present invention, it is always required first to detect the zero current of the choke coil 12 and then to turn ON the high and low side power MOS FETs 10 and 15. As a result, the high and low side power MOS FETs are operated in a zero current turn-on mode, so that, when the high and low side power MOS FETs 10 and 15 are turned ON, no recovery loss takes place. The diode 4 and the capacitor 7 form a boot strap circuit, and the capacitor 7 is charged up to about 15V in the free wheeling mode B.

The smoothing output capacitor 16 is initially charged in this way and the voltage thereacross increases. The voltage of the smoothing output capacitor 16 is detected by the initial charge judgment circuit 38. When the detected voltage reaches a predetermined level, the initial charge judgment circuit 38 determines the current mode as a stationary operation mode, thus turning the switch 30 to a terminal connected to the constant current source 29 as the position of the stationary mode and turning ON the switch 43. An arrangement of the switch 30, the variable current source 28, and the constant current source 29 is illustrated in a model form. However, the arrangement may be made so that a single constant current source is prepared and the current of the constant current source is varied proportionally to the input voltage in the initial charge mode.

Explanation will then be made as to the stationary operation mode. The stationary operation mode is different from the initial charge mode in that the constant current source 29 is used and in that the operation mode is changed according to a magnitude relationship between the input voltage 35 and the voltage of the smoothing output capacitor 16.

In the stationary operation mode, the capacitor 34 is charged by the constant current source 29. Although the output of the error amplifier 31 varies with the magnitude relationship between the voltage of the smoothing output capacitor 16 and the voltage reference 32, the output becomes nearly constant when control becomes stable. The low side power MOS FET 15 is turned OFF when the output voltage of the error amplifier 31 coincides with the charge voltage of the capacitor 34. Thus, the period of the mode A in FIG. 2 or in other words, the ON time becomes nearly constant independently of the instantaneous value of the input voltage (input voltage 35). At this time, the current increase rate of the choke coil 12 is proportional to the input voltage Vin (instantaneous value) according to the equation (1). When the ON time (Ton) is constant, the peak current is also proportional to the voltage Vin.

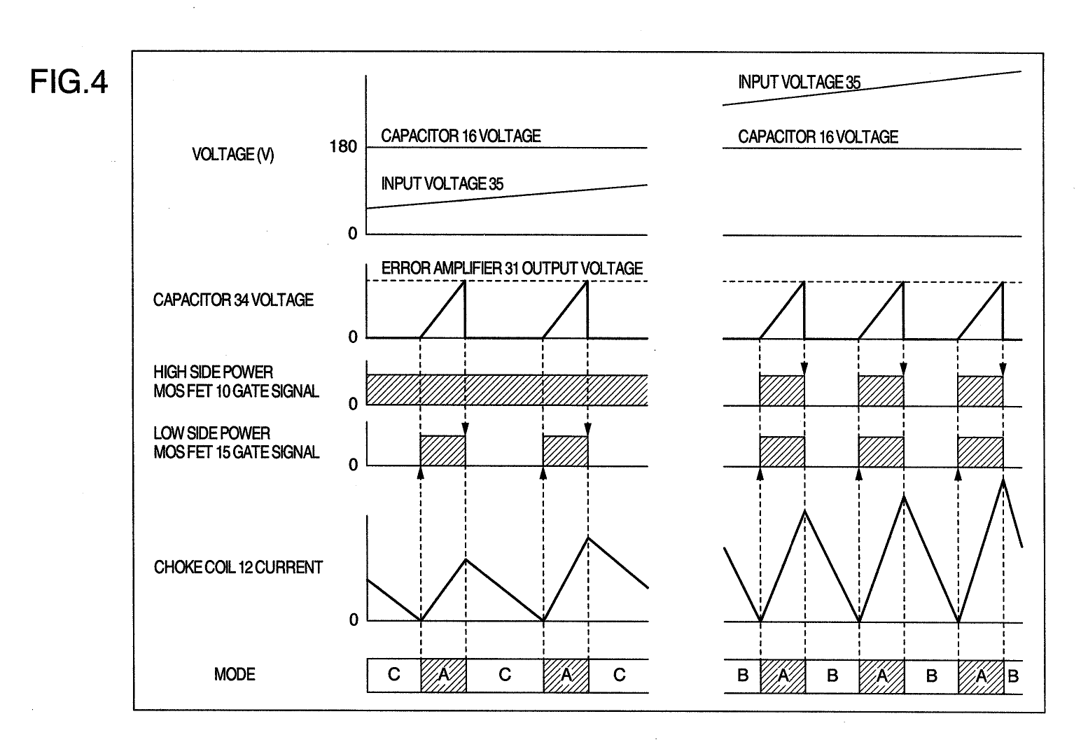

Explanation will next be made as to a mode change based on a magnitude relationship between the input voltage 35 and the voltage of the smoothing output capacitor 16 in the stationary operation mode, by referring to FIG. 4. In the drawing, the voltage of the smoothing output capacitor 16 is set at 180V. In this connection, this voltage can be specified at an easy-to-use voltage by the user. The value of a voltage obtained by dividing the input voltage 35 by the voltage division resistances 22a, 22b and the value of a voltage obtained by dividing the voltage of the smoothing output capacitor 16 by the voltage division resistances 33a, 33b are input to the comparator 23. The comparator 23 compares these input voltages. When the instantaneous value of the input voltage 35 is lower than the voltage of the smoothing output capacitor 16, the comparator 23 causes the high side power MOS FET 10 to have a high level of gate voltage. The offset 24 is inserted in a path from the input of the comparator to the smoothing output capacitor 16 for receiving the voltage corresponding to the division of the voltage of the smoothing output capacitor 16. The offset 24 converts the input voltage to the output voltage, which in turn corresponds to 10-20V. As a result, the comparator 23 compares the input voltage 35 with a voltage obtained by subtracting the voltage of the offset 24 of 10-20V (Vof24) from the voltage of the smoothing output capacitor 16 for changeover. When the comparator 23 produces a high level of output, the switch 43 is turned ON. Thus the OR circuit 20 produces a high level of output, and the high side power MOS FET 10 is turned ON, so that the mode when the low side power MOS FET 15 is turned ON becomes the mode A (see FIG. 2) which is the same as the initial charge mode. When the low side power MOS FET 15 is turned OFF, however, the mode is changed to the mode C. In the mode C, a current flows through a path of input power supply—high side power MOS FET 10—choke coil 12—boost diode 14—smoothing output capacitor 16 to supply an energy into the smoothing output capacitor 16. A difference between the modes B and C lies in whether or not the current flows through the input power supply. In the mode C, a path including the input power supply is established. Thus the mode C has a merit over the mode B, that the input current is continuous regardless of the turned ON and OFF states of the low side power MOS FET 15 when viewed from the input side, the input current has a higher effective waveform value than in the mode B, and the waveform of the input filter 2 can be more easily smoothed. In the mode of the present invention, a power factor can be advantageously increased by increasing the input current when the AC input voltage is lower than in the prior art H bridge control method.

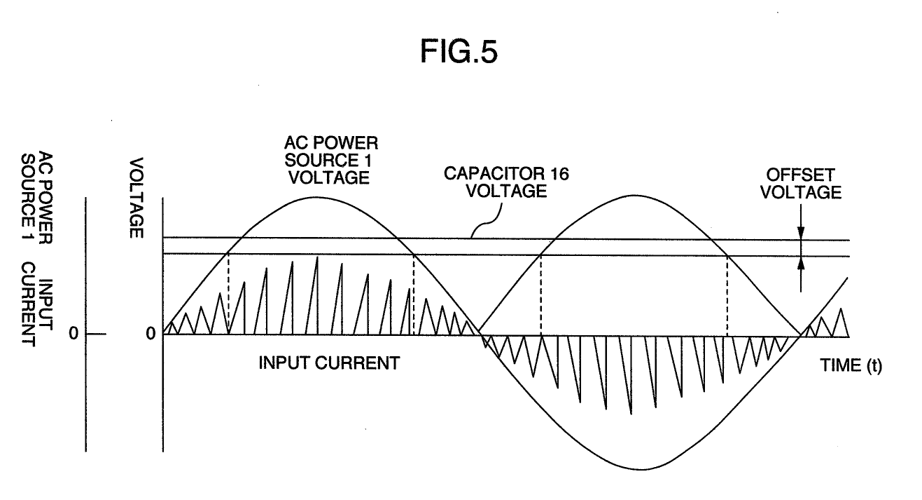

FIG. 5 shows a mode change and waveforms of the input current and voltage caused by the input voltage 35 and the voltage of the smoothing output capacitor 16 in the present invention. In a zone where the voltage of the AC power source 1 is lower than a voltage obtained by subtracting an offset voltage from the voltage of the smoothing output capacitor 16, the high side power MOS FET 10 is put in its turned-ON state. As the voltage of the AC power source 1 is higher, the high side power MOS FET 10 is switched simultaneously with the low side power MOS FET 15. This difference is as shown in FIG. 4. In FIG. 4, a left side shows a state of the switching power supply when the input voltage is low, and the power supply is operated based on the modes A and C. In FIG. 4, a right side shows a state of the switching power supply when the input voltage is high, and the power supply is operated based on the modes A and B.

As mentioned above, in a zone when the input voltage is lower than the voltage of the smoothing output capacitor 16, the input current is in the critical mode. The waveform of the input voltage is when viewed from the AC side of the rectifier 3, and in the input side of the input filter 2, the current in the low voltage zone is smoothed into a continuous waveform. When the H bridge is operated simply in the current critical mode, the frequency becomes high but this also can advantageously keep the current low. That is, in the mode C, a relationship is satisfied as follows.

−di/dt=(Vout−Vin)/L (6)

When compared with the equation (5) (−di/dt=Vout/L) in the mode B, the equation (6) has an attenuation current gradient more slower than the equation (5), a time until the current flowing through the choke coil 12 becomes zero is longer. As a result, when the input voltage is low, the high side power MOS FET 10 is turned ON, so that the use of the mode C advantageously enables reduction of the switching frequency to a low level.

The switch 43 is not necessarily required. In the absence of the switch 43, even in the initial charge mode, there takes place a zone where the high side power MOS FET 10 is turned ON according to a relationship among a predetermined offset voltage, the input voltage 35 and the voltage of the smoothing output capacitor 16. This has substantially no effect on the initial charge waveform.

In this embodiment, when a signal from the ON/OFF signal input terminal 44 is turned OFF, drive signals for the high and low power MOS FETs 10 and 15 are all turned OFF, so that the operations of the RS flip-flop 21, the constant current source 29, and the comparators 23, 26 are also stopped. For example, when it is desired to stop the operation of a load outside of the switching power supply, the ON/OFF operation of a supply power can be controlled by providing an OFF signal to the ON/OFF signal input terminal 44.

In accordance with the present invention, the initial charging operation of the smoothing output capacitor 16 can be easily and reliably achieved and a rush current can be prevented. Thus this can eliminate the need for provision of a rush current preventing resistance or thermistor and a relay for short-circuiting it, which have been required in the prior art. Further, since the ON/OFF operation of outputs of the PFC circuit and subsequent circuits can be controlled from the ON/OFF signal input terminal 44, the relay for the ON/OFF switch so far mounted in the input side in the prior art can be eliminated. As a result, components in the switching power supply can have a compact and reduced-height arrangement, and thus a very-flat power supply can be attained.

In the present embodiment, a P-channel type power MOS FET may be employed as the high side power MOS FET 10. In this case, not only the structure of the driver 8 can be simplified but also the need for provision of a boot strap circuit for the diode 4 and the capacitor 7 can be eliminated.

When the IC 36 shown in FIG. 1 is integrated in the form of a single chip by using a high breakdown voltage process, the switching power supply can be made most compact with an increased user handleability.

The IC 36 may be attained by employing a method of packing a plurality of chips into a single package. The level shift circuit 9 and the driver 8 may be made in the form of a single drive IC, and components other than the IC 36 may be combined into a single control IC, thus forming a control circuit of the 2 ICs. When this method is employed, the prior art process of the PFC control IC for manufacturing the IC 36 can be used as it is. Thus the IC manufacturer can be only required to slightly modify the function of the prior art PFC control IC and thus the IC development cost can be reduced.

### Embodiment 2

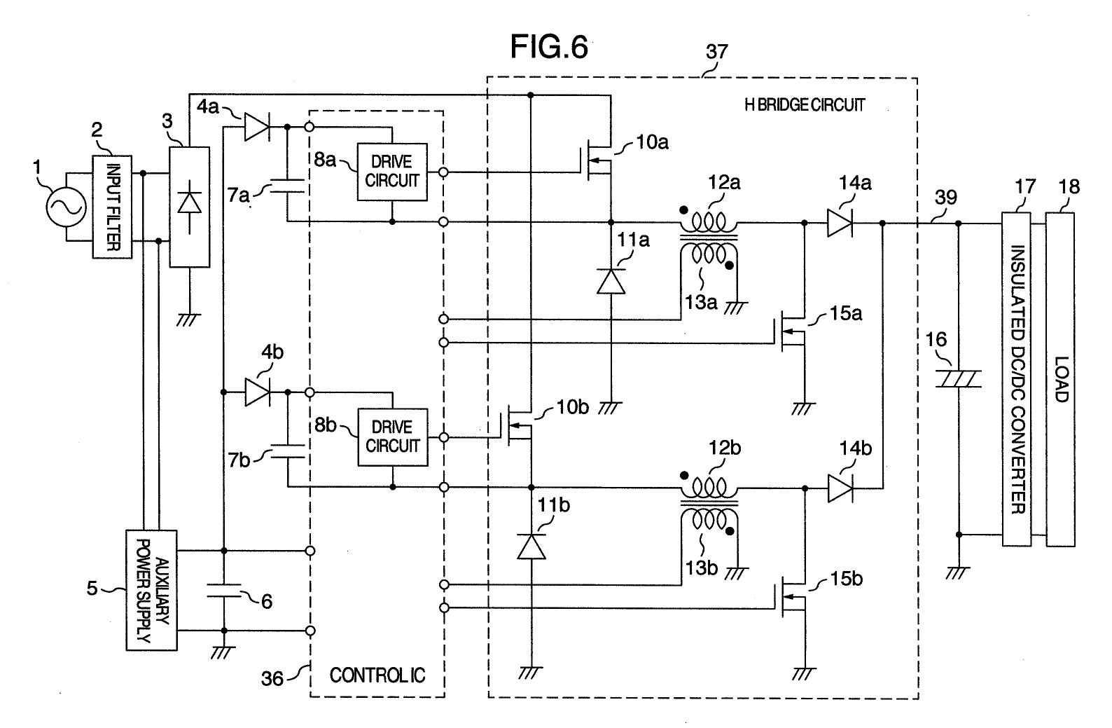

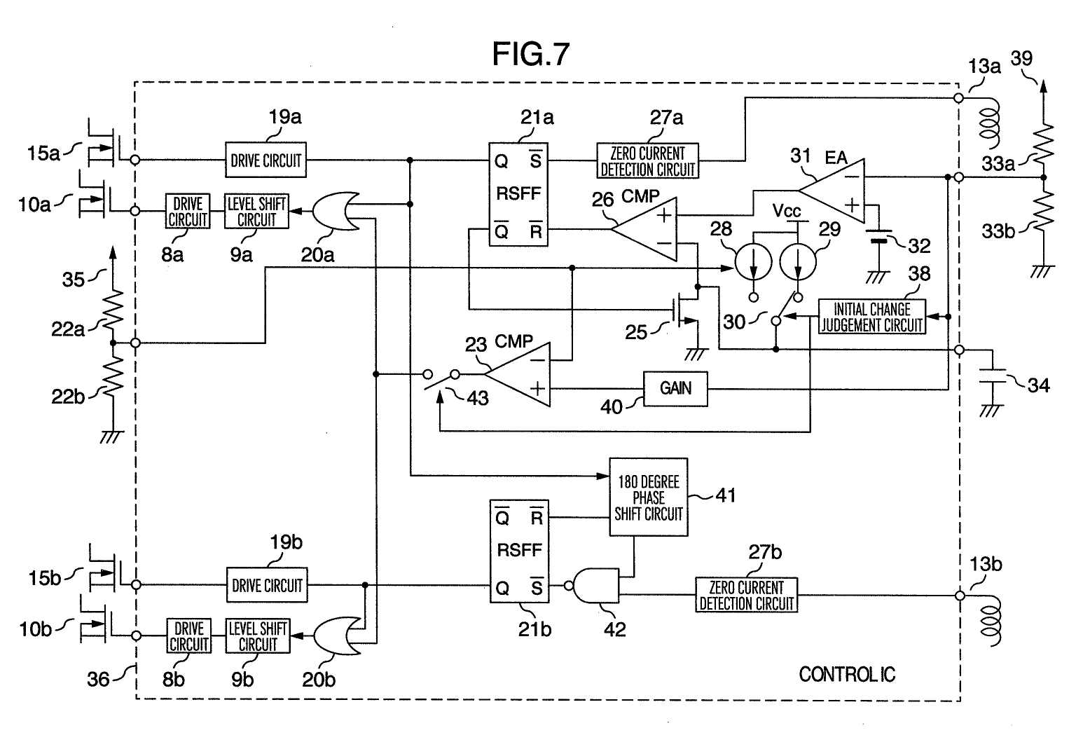

Explanation will then be made as to a second embodiment of the present invention with reference to FIGS. 6, 7, 8, and 9. FIG. 6 shows a main circuit in a buck-boost switching power supply, and FIG. 7 is a control circuit therefor. In FIGS. 6 and 7, constituent elements having the same functions as those in FIG. 1 are denoted by the same reference numerals or symbols. The main circuit of FIG. 6 is different from that in FIG. 1 in that two of the H bridge circuits are prepared as the main circuit and these H bridge circuits are connected in parallel. That is, the interconnection configuration of a high side power MOS FET 10a, a free wheeling diode 11a, a choke coil 12a, a low side power MOS FET 15a, and a boost diode 14a in the H bridge circuit 37 is the same as that of the main circuit in FIG. 1. In addition to this, FIG. 6 includes a high side power MOS FET 10b, a free wheeling diode 11b, a choke coil 12b, a low side power MOS FET 15b, and a boost diode 14b, with the same interconnection configuration as the above-mentioned interconnection configuration. The high side power MOS FETs 10a and 10b are commonly connected at their drains, and the drain common point is connected to the input voltage 35, the boost diodes 14a and 14b are commonly connected at their cathodes, and the cathode common point is connected to the smoothing output capacitor 16. The connection configuration among the smoothing output capacitor 16, the insulated DC/DC converter 17 and the load 18 provided downstream thereof is the same as that of FIG. 1. The choke coils 12a, 12b have auxiliary windings 13a and 13b respectively, and respective winding starts are grounded. In the control IC 36 shown in FIG. 6, drive circuits 8a and 8b connected to the high side power MOS FETs 10a and 10b are illustrated. The drive circuits 8a, 8b are connected to capacitors 7a, 7b provided outside of the control IC respectively. The capacitors 7a, 7b are connected to cathodes of the diodes 4a, 4b, which in turn are connected at their anodes to the capacitor 6 respectively. The capacitor 6 is connected to the auxiliary power source 5.

Explanation will next be made as to the connection of the circuit diagram of FIG. 7. FIG. 7 shows an interior of the control IC 36 in FIG. 6 (enclosed by a dotted line), and also shows circuit elements provided outside of the IC interior and illustrated in FIG. 6. The interconnection configuration of FIG. 7 is similar to that of FIG. 1. That is, the interconnection configuration of FIG. 7 is among voltage division resistances 33a, 33b, an error amplifier 31, a voltage reference 32, a comparator 26, an auxiliary winding 13a, a zero current detection circuit 27a, an RS flip-flop 21a, a MOS FET 25, a variable current source 28, a constant current source 29, a switch 30, an initial charge judgment circuit 38, a capacitor 34, a drive circuit 19a, a low side power MOS FET 15a, a comparator 23, an OR circuit 20a, a level shift circuit 9a, a drive circuit 8a, a high side power MOS FET 10a, and a switch 43.

The present embodiment is different from the embodiment of FIG. 1 in that a gain 40 is provided in place of the offset 24 shown in FIG. 1. An output of the initial charge judgment circuit 38 and an output of the RS flip-flop 21a are input to a 180-degree phase shift circuit 41. An output of the 180-degree phase shift circuit 41 is input to a NAND circuit 42 newly provided and a reset terminal of an RS flip-flop 21b. The auxiliary winding 13b is connected to a zero current detection circuit 27b, which in turn is connected to the NAND circuit 42. An output of the NAND circuit 42 is applied to a set terminal of the RS flip-flop 21b. A Q output of the RS flip-flop 21b is connected to a drive circuit 19b and an OR circuit 20b, and the drive circuit 19b is connected to a gate of the low side power MOS FET 15b. An output of the comparator 23 is connected to the OR circuit 20b. An output of the OR circuit 20b is connected to a gate of the high side power MOS FET 10b via a level shift circuit 9b and the drive circuit 8b.

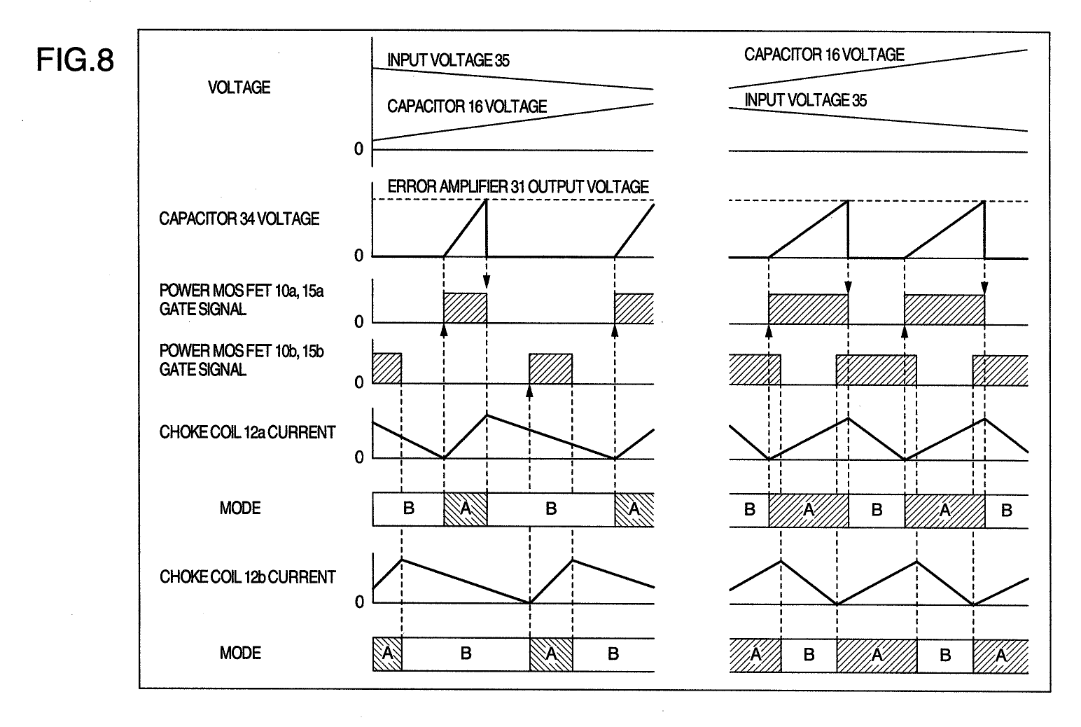

The operation of the present invention will then be explained. The basic operation of the present embodiment is the same as that in the operation of FIG. 1 and has the initial charge mode and the stationary operation mode. In the initial charge mode, as shown by waveforms of signals at various points in FIG. 8, the voltage of the smoothing output capacitor 16 starts from zero and the divided voltage input to the error amplifier 31 is much smaller than the voltage reference 32, so that the error amplifier 31 has a constant output voltage. Thus, as shown in FIG. 8, the voltage of the capacitor 34 reaches the output voltage of the error amplifier 31 at such a time as to be inversely proportional to the input voltage 35, so that the comparator 26 is inverted to reset the RS flip-flop 21a. At this time, a current so far flowing through the choke coil 12a becomes a peak, and the smoothing output capacitor 16 is charged with the current in the mode B of FIG. 2. A time point when the current of the choke coil 12a becomes zero is detected by the auxiliary winding 13a and the zero current detection circuit 27a to set the RS flip-flop 21a. This operation is repeated as in the embodiment 1. In the present embodiment, in addition to it, another H bridge circuit is operated. The output of the RS flip-flop 21a, that is, the output of the ON signal of the low side power MOS FET 15a is input to the 180-degree phase shift circuit 41. The 180-degree phase shift circuit 41 calculates an ON duration of the Q output of the RS flip-flop 21a and a period thereof, generates a signal lagging the calculated signal by a phase of 180 degrees, outputs the set signal to the NAND circuit 42 at this timing, and also outputs the reset signal to the RS flip-flop 21b. A current of the H bridge including the choke coil 12b is detected by the auxiliary winding 13b and the output of the zero current detection circuit 27b, and then applied to the NAND circuit 42. Firstly when the timing of the set signal issued from the 180-degree phase shift circuit 41 coincides with the zero detection signal, a set signal is issued from the NAND circuit 42 and then applied to the RS flip-flop 21b as a set signal. With such operation of the circuit, the H bridge including the choke coil 12b has a current waveform lagging the H bridge including the choke coil 12a by a phase of 180 degrees, and is operated in such a current critical mode or current discontinuous mode as to cause always no diode recovery problem.

The currents of the choke coils 12a and 12b in the initial charge mode have waveforms which are 180 degrees out of phase as shown in FIG. 8. During a time from the zero voltage of the smoothing output capacitor 16 up to the full charged voltage thereof, the peak value of the current of one choke coil is always equal to that of the other choke coil. As a result, the smoothing output capacitor 16 is quickly charged with the waveforms of less current ripple. Since the smoothing output capacitor 16 can be quickly charged, this can contributes to the shortening of the boot time of a device having the switching power supply of the present invention mounted therein.

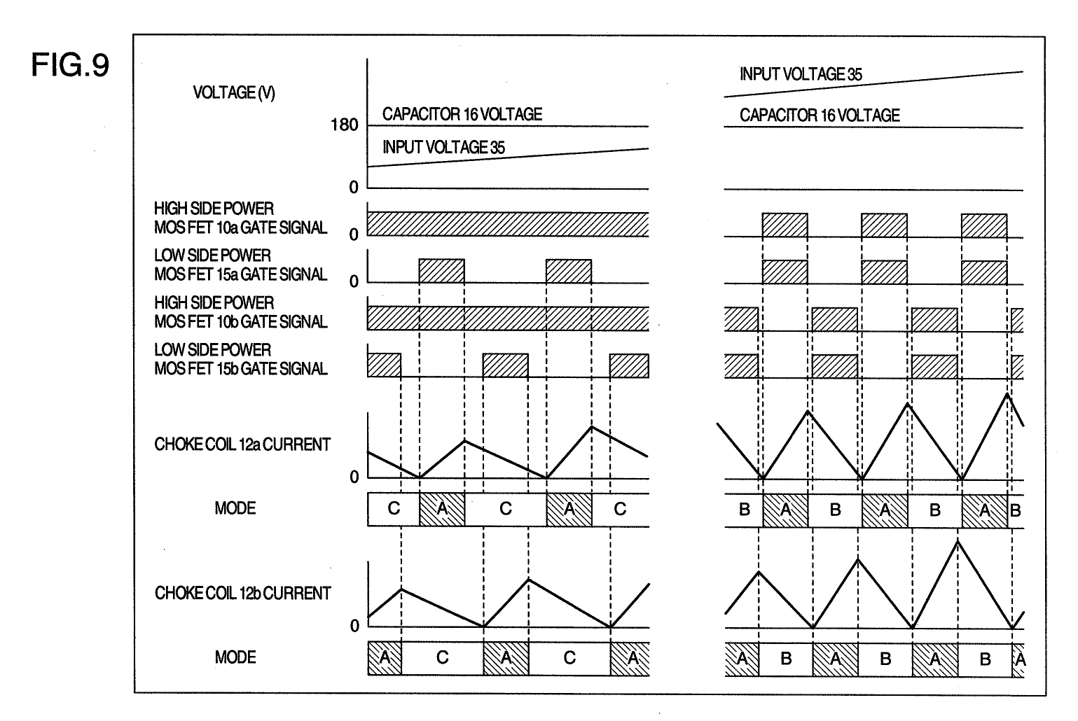

Even in the stationary mode, the currents flowing through the choke coils have current critical waveforms which are 180 degrees out of phase as shown in FIG. 9. With respect to the high side power MOS FETs 10a, 10b, a voltage (corresponding to a division of the input voltage 35 divided by the voltage division resistances 22a, 22b) detected from the input voltage 35 is compared with a voltage obtained by multiplying a voltage (corresponding to a division of the capacitor voltage divided by the voltage division resistances 33a, 33b) detected from the smoothing output capacitor 16 by the gain 40. When the latter is larger, the high side power MOS FETs 10a, 10b are switched simultaneously with the low side power MOS FETs 15a, 15b. Conversely, when the voltage (corresponding to the division of the input voltage 35 divided by the voltage division resistances 22a, 22b) detected from the input voltage 35 is smaller than the voltage obtained by multiplying the voltage (corresponding to the division of the capacitor voltage divided by the voltage division resistances 33a, 33b) detected from the smoothing output capacitor 16 by the gain 40, the high side power MOS FETs 10a, 10b are put in the ON state. The operations of the modes of the H bridge circuits are as shown in FIG. 9.

The present embodiment will be referred to as the 2-phase interleave H bridge type converter. When not a 1-phase H bridge system but the 2-phase interleave H bridge system is employed, the high side power MOS FETs 10a, 10b are operated with a phase difference of 180 degrees, so that the 2-phase H bridge system can advantageously reduce the discontinuous duration of the input current to a large extent.

Based on the current waveforms of the choke coils 12a, 12b, the ripple components of the input current can advantageously be reduced. Since the choke coil, the high side power MOS FET 10, and the low side power MOS FET 15 are each divided into two sections, the heat can be more dissipated. The initial charging operation of the smoothing output capacitor 16 can be easily and reliably achieved and a rush current can be prevented. Thus there can be eliminated the need for provision of a rush current preventing resistance or thermistor and a relay for short-circuiting it, which have been required in the prior art. This results in that components used in the switching power supply can be made compact and flat and a very flat power supply can be attained.

A semiconductor package for a switching power supply of an about 200 W class is as follows. The rectifier can be a diode bridge having a highest thickness of 5.3 mm; each of the high side power MOS FETs 10a, 10b, the low side power MOS FETs 15a, 15b, the free wheeling diodes 11a, 11b, and the boost diodes 14a, 14b can have a highest thickness of 4.7 mm; the core of each of the choke coils 12a, 12b can have a thickness of 9 mm; and the smoothing output capacitor 16 can be an electrolytic capacitor having a diameter of 6 to 10 mm. In this connection, when holes are made in a substrate for mounting the choke coils and devised, a flat switching power supply having a thickness smaller than 10 mm can be attained.

When such a switching power supply having a thickness smaller than 10 mm is mounted on the rear surface of a liquid crystal panel of a television set or on the rear surface of a panel of an image monitor device, the panel can be made to have a thickness not smaller than 20 mm and not larger than 35 mm.

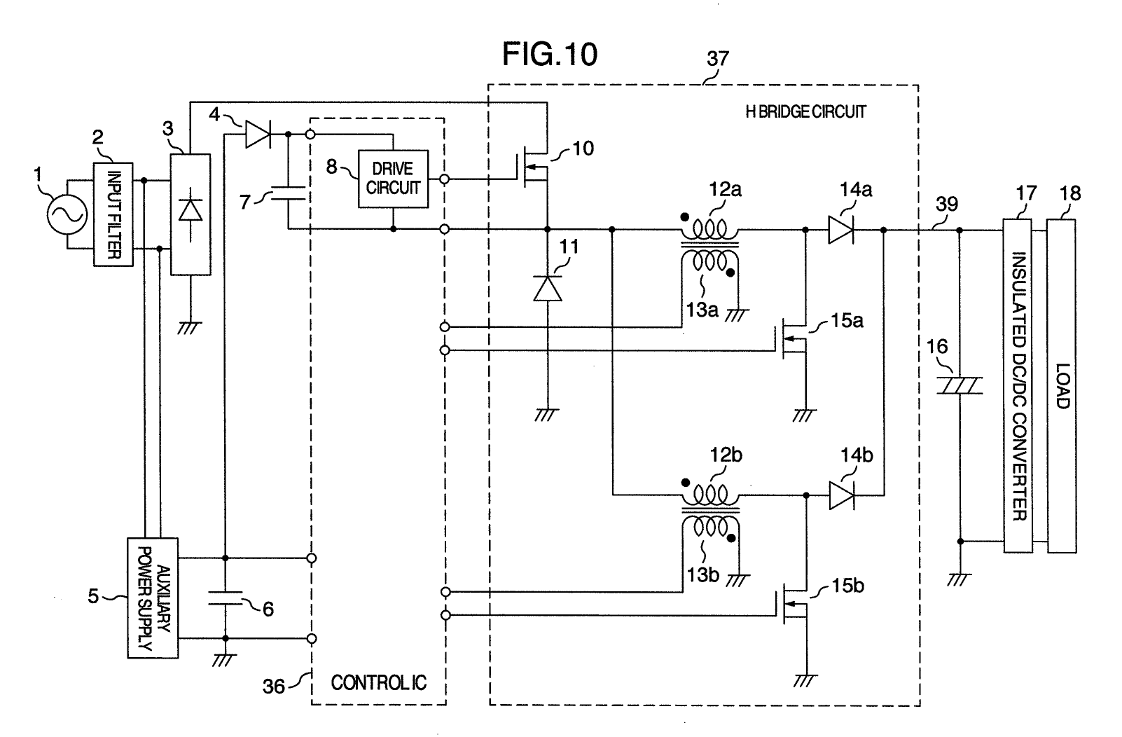

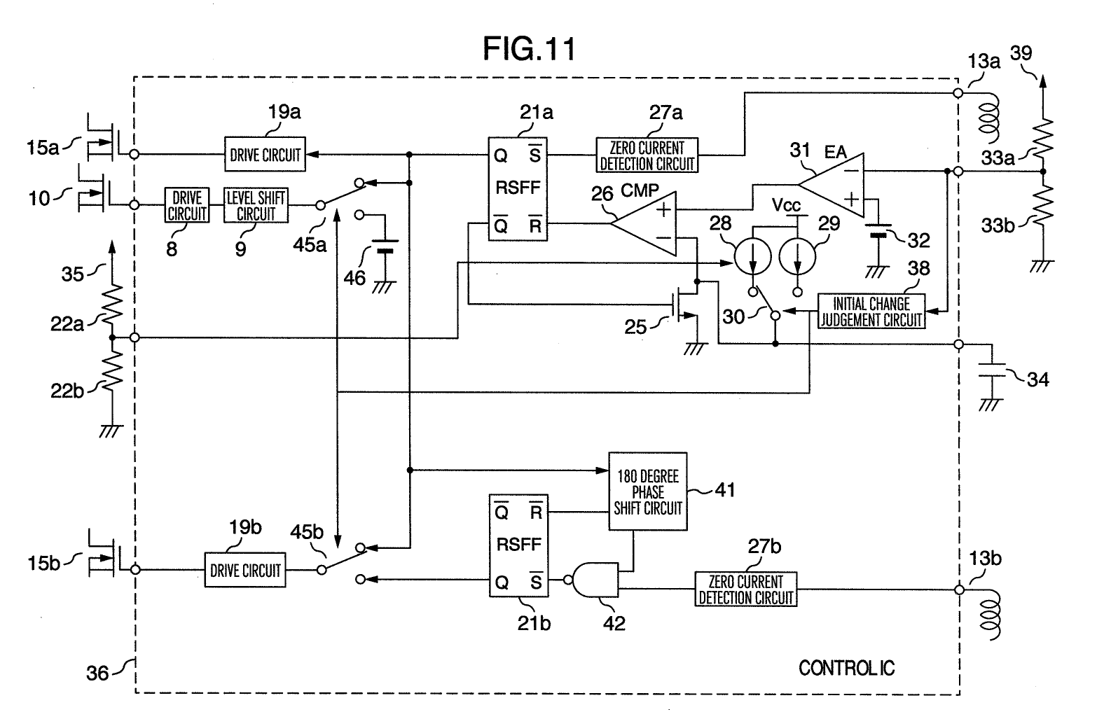

Another embodiment of the present invention will be explained by referring to FIGS. 10 and 11.

FIG. 10 shows a main circuit of a buck-boost switching power supply in accordance with an embodiment of the present invention similar to FIG. 6 or 1. In FIG. 10, constituent elements having the same functions as those in FIG. 6 or 1 are denoted by the same reference numerals or symbols. Only points different from FIG. 6 will be explained. In FIG. 10, the interconnection configuration of the H bridge circuit 37 including the high side power MOS FET 10, the free wheeling diode 11, the choke coil 12a, the low side power MOS FET 15a, and the boost diode 14a is the same as in the main circuit of FIG. 1 or 6. A difference of FIG. 10 from FIG. 6 lies in that the choke coil 12b is connected to the choke coil 12a in parallel and the two choke coils are connected to a source of the high side power MOS FET 10. In other words, the high side power MOS FET 10b and the drive circuit thereof illustrated in FIG. 6 are omitted.

Explanation will next be made with reference to FIG. 11. FIG. 11 shows a control circuit of the buck-boost switching power supply of the present invention similar to FIG. 7. In FIG. 11, constituent elements having the same functions as those in FIG. 7 are denoted by the same reference numerals or symbols. FIG. 11 is different from FIG. 7 in that a switch 45a is inserted between a Q output of the RS flip-flop 21a and the level shift circuit 9 and a voltage source 46 is connected to the other input of the switch 45a, in that a switch 45b is inserted between the Q output of the RS flip-flop 21a and the drive circuit 19b and a Q output of the RS flip-flop 21b is connected to the other input of the switch 45b, and in that control terminals of the switches 45a, 45b are connected to the initial charge judgment circuit 38. In this connection, in this drawing, the high side power MOS FET 10b, the level shift circuit 9b, the drive circuit 8b, the OR circuits 20a, 20b, the switch 43, the comparator 23, and the gain 40 in FIG. 7 are omitted.

Explanation will then be made as to the operations of FIGS. 10 and 11. In the present embodiment, the output voltage 39 is set to have a value larger than the maximum of a voltage crest value of the AC power source 1. In FIG. 10, when the initial charge judgment circuit 38 determines the initial charge mode based on the output voltage, the switch 30 in FIG. 11 is connected to the variable current source 28, and the switches 45a, 45b are connected to a Q output side of the RS flip-flop 21a. As a result, in the initial charge mode, three of the high side power MOS FET 10 and the low side power MOS FETs 15a, 15b in the H bridge circuit 37 are simultaneously turned ON or OFF. The then ON time of each power MOS FET varies with the instantaneous value of the input voltage. The ON time is detected by detecting the instantaneous value of the input voltage by the voltage division resistances 22a, 22b, converting the detected instantaneous value to a current value with use of the variable current source 28, and converting it to an ON time width with use of the capacitor 34 and the comparator 26. In the then operation, the modes A and B in FIG. 2 are alternately repeated so that the same current flows through the two choke coils 12a, 12b. The current flowing through the choke coils 12a, 12b has such a critical current waveform as shown in FIG. 3. A total of currents flowing through the low side power MOS FETs 15a, 15b flows through the high side power MOS FET 10.

As the output voltage 39 increases, determination of the end of the initial charge mode by the initial charge judgment circuit 38 causes the switch 30 to be switched to a terminal connected to the constant current source 29. Simultaneously, the switch 45a is switched to a terminal connected to the voltage source 46, and the switch 45b is switched to a terminal connected to a Q output of the RS flip-flop 21b.

As a result, the high side power MOS FET 10 is put always in the ON state. Meanwhile, similarly to in FIG. 8, the low side power MOS FETs 15a, 15b are turned ON and OFF at timings shifted by a phase of half the period, thus enabling control of power factor correction.

In accordance with the present embodiment, since the high side power MOS FET 10 is employed to provide a control means for initially charging the smoothing output capacitor at a high speed with a constant current, there is attained a switching power supply which can eliminate the need for provision of the initial charge resistance and relay.

As has been explained above, in accordance with the foregoing embodiments of the present invention, such a control means as to initially charge the smoothing output capacitor at high speed with a constant current is provided in the H bridge buck-boost circuit of the current critical mode control type, so that there can be attained a switching power supply which eliminates the need for provision of the initial charge resistance and relay.

The present invention can be applied to information equipment operated on an input commercial AC power such as an electric device, an air conditioner, a home electric appliance, a personal computer, or a server.

It should be further understood by those skilled in the art that although the foregoing description has been made on embodiments of the invention, the invention is not limited thereto and various changes and modifications may be made without departing from the spirit of the invention and the scope of the appended claims.

1. A buck-boost switching power supply including an H bridge converter at an input stage having a high side switch and a low side switch connected in series via a choke coil,
wherein the high side switch is turned ON and the low side switch is turned ON and OFF when an absolute value of an instantaneous value of an input voltage is lower than an output voltage, and the high side switch and the low side switch are simultaneously turned ON or OFF to put the current of the choke coil in a critical mode when the absolute value of the instantaneous value of the input voltage is higher than the output voltage, thus controlling power factor correction.

2. The buck-boost switching power supply according to claim 1, wherein an initial charge mode is provided when an output voltage of a smoothing output capacitor is lower than a predetermined voltage, and the high side switch and the low side switch are simultaneously switched with a time width inversely proportional to the instantaneous value of the input voltage in the initial charge mode for current critical mode operation.

3. The buck-boost switching power supply according to claim 1 comprising an integrated circuit,
the integrated circuit including:
a control circuit having the initial charge mode and a mode for correction of a power factor of an input power;
a level shift circuit for transmitting a drive signal of the high side switch to a high voltage side; and
drive circuits for the high and low side switches.

4. The buck-boost switching power supply according to claim 3, wherein the integrated circuit has a terminal for receiving a power boot/shutdown signal externally of the switching power supply.

5. The buck-boost switching power supply according to claim 2, wherein the H bridge converters are provided as at least two channels, and the respective H bridge converters are interleaved in the initial charge mode and in the power factor correction control mode.

6. A buck-boost switching power supply wherein a semiconductor switching element and a choke coil used for control of power factor correction cause a current peak value of the smoothing output capacitor in the initial charge mode to be controllably made constant.

7. The buck-boost switching power supply according to claim 1, wherein a unit has a full height not smaller than 6 mm and smaller than 10 mm, the unit is mounted on a rear side of a liquid crystal panel of a television set or on a rear side of an image monitor device, and the panel when the unit is set thereon has a thickness not smaller than 20 mm and not larger than 35 mm.

8. The buck-boost switching power supply according to claim 2, comprising an integrated circuit,
the integrated circuit including:
a control circuit having the initial charge mode and a mode for correction of a power factor of an input power;
a level shift circuit for transmitting a drive signal of the high side switch to a high voltage side; and
drive circuits for the high and low side switches.

9. The buck-boost switching power supply according to claim 3, wherein the H bridge converters are provided as at least two channels, and the respective H bridge converters are interleaved in the initial charge mode and in the power factor correction control mode.

10. The buck-boost switching power supply according to claim 4, wherein the H bridge converters are provided as at least two channels, and the respective H bridge converters are interleaved in the initial charge mode and in the power factor correction control mode.

11. The buck-boost switching power supply according to claim 6, wherein a unit has a full height not smaller than 6 mm and smaller than 10 mm, the unit is mounted on a rear side of a liquid crystal panel of a television set or on a rear side of an image monitor device, and the panel when the unit is set thereon has a thickness not smaller than 20 mm and not larger than 35 mm.
